(19) United States
(12) Patent Application Publication
(10) Pub. No.: US 2006/0139212 A1
(43) Pub. Date: Jun. 29, 2006

(54) Antenna

(76) Inventor: Terry Reuss, Gauteng (ZA)

Correspondence Address: LADAS & PARRY LLP, 224 SOUTH MICHIGAN AVENUE, SUITE 1600, CHICAGO, IL, 60604, US

(21) Appl. No.: 11/274,991

(22) Filed: Nov. 16, 2005

(30) Foreign Application Priority Data
Nov. 17, 2004 (ZA) 2004/9203

(51) Int. Cl. H01Q 1/38

(52) U.S. Cl. 343/700 MS

(57) ABSTRACT

An antenna includes a multi sided electrical conductor forming a ground plane has two diagonals of different lengths. A multi sided electrical conductor forming a radiator has two diagonals of different lengths and a dielectric substrate is connected to the ground plane and to the radiator thereby to separate the ground plane from the radiator.

### BACKGROUND OF THE INVENTION

THIS invention relates to an antenna, particularly to a dual frequency dual polarised patch antenna with applications for satellite communication systems.

### SUMMARY OF THE INVENTION

In one aspect an antenna includes:
a multi sided electrical conductor forming a ground plane, wherein two diagonals of the ground plane are of different lengths;
a multi sided electrical conductor forming a radiator wherein two diagonals of the radiator are of different lengths; and
a dielectric substrate connected to the ground plane and to the radiator thereby to separate the ground plane from the radiator.

### BRIEF DESCRIPTION OF THE DRAWINGS

FIG. 1 is a schematic representation of a first embodiment of an antenna;

FIG. 2 is a VSWR plot of the antenna of FIG. 1;

FIGS. 3 and 4 illustrates the Horizontal and Vertical radiation pattern of the antenna of FIG. 1 at the two resonant frequencies;

FIG. 5 illustrates a schematic representation of a second embodiment of an antenna; and

FIG. 6 illustrates a schematic representation of a third embodiment of an antenna.

### DESCRIPTION OF EMBODIMENTS

Referring to FIG. 1, an antenna 10 according to the present invention comprises a square or rectangular electrical conductor 12 forming a ground plane.

A square or rectangular electrical conductor forms a radiator 12.

The ground plane and the radiator are connected to a dielectric substrate 14, on opposing sides of the dielectric substrate that separates the two.

It will be appreciated that in one example, the ground plane, radiator and dielectric substrate are of substantially the same shape.

The dielectric substrate of a prototype was manufactured from a material consisting of titanium dioxide powder, a dispersant and a polyester resin that cures with the addition of a catalyst. The powder is mixed with the resin and dispersant and cast into a slab. The ratio of the powder to the resin is greater than 2:1.

The diagonals of the ground plane, radiator and dielectric substrate are of different lengths. Thus, the diagonal indicated as having length “A” is different from the length of the diagonal indicated as having length “B”. Diagonal for example refers to a line segment connecting two non-adjacent vertices of a polygon.

This difference is effected by cutting off one of the corners 16.

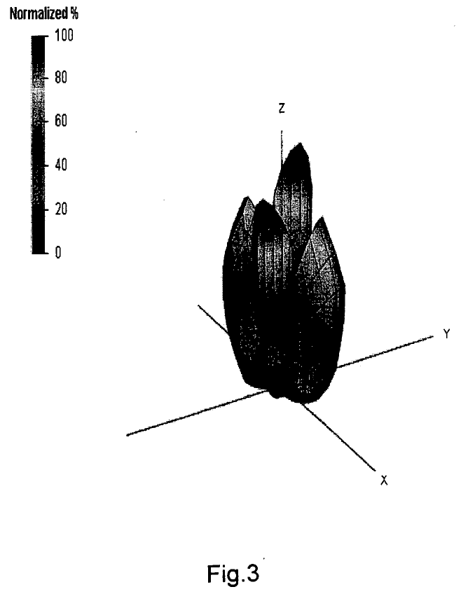

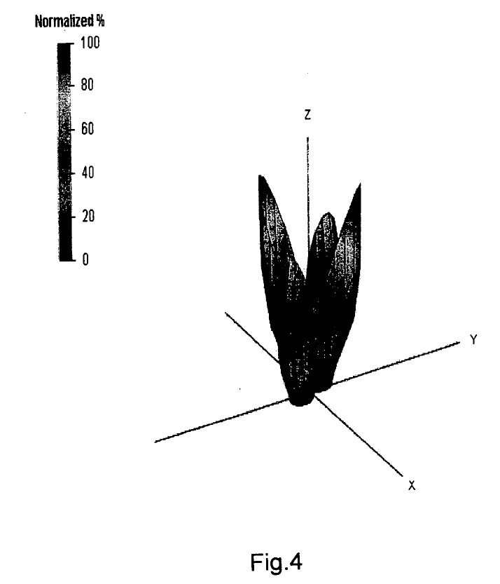

The surface current at the lower frequency flows along the length of diagonal A and the current at the higher frequency flows along the diagonal B. This produces electromagnetic waves with orthogonal polarization. E and H plane radiation patterns are shown in FIGS. 3 and 4.

A coaxial feed point is connected to the radiator in the centre of one of the shortages 18.

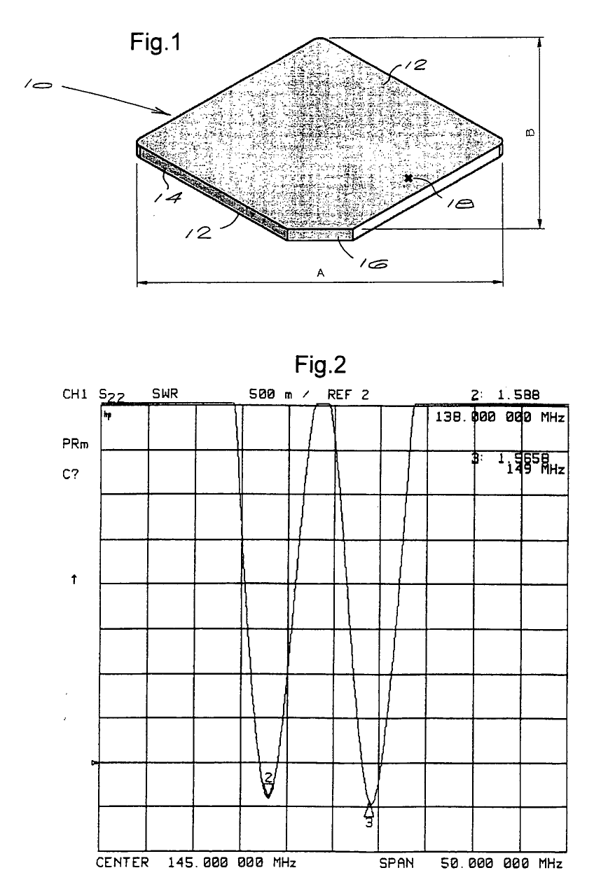

The different length diagonals produce a dual frequency operation. This is illustrated in FIG. 2.

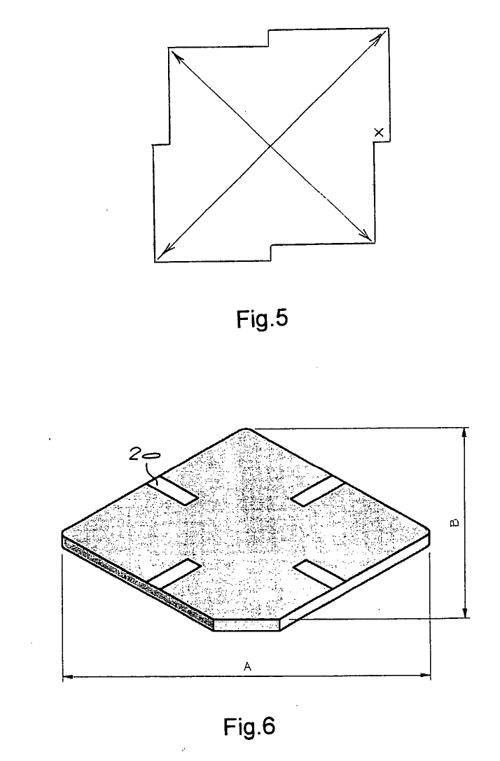

FIG. 5 illustrates a second embodiment wherein the electric conductor forming the radiator is multi sided but still includes two diagonals of different lengths.

FIG. 6 illustrates a third embodiment invention wherein the electric conductor forming the radiator is removed to provide for non-conductive slots 20.

The slots 20 begin at or near the edges of the radiator and extend inwardly towards a centre point of the radiator.

The slots 20 lower the resonant frequency of the antenna.

The antenna can be used for the transmission and reception of satellite communications at two frequencies.

In a prototype antenna, for a frequency of operation of 140 MegaHertz and 150 MegaHertz, the dimensions of the antenna include a 15 mm thick dielectric substrate with a relatively permittivity ER in the order of 10.

The longer diagonal is approximately 390 mm and the shorter diagonal is approximately 350 mm. The slots are approximately 20 mm wide and 70 mm long.

A prototype of the antenna produced resonant frequencies of 137.5 and 149 respectively being a frequency ratio of 1.084.

1. An antenna including:
a multi sided electrical conductor forming a ground plane, wherein two diagonals of the ground plane are of different lengths;
a multi sided electrical conductor forming a radiator wherein two diagonals of the radiator are of different lengths; and
a dielectric substrate connected to the ground plane and to the radiator thereby to separate the ground plane from the radiator.

2. An antenna according to claim 1 wherein the dielectric substrate is of a constant thickness.

3. An antenna according to claim 1 wherein the ground plane, radiator and dielectric substrate are of substantially the same shape.

4. An antenna according to claim 1 wherein a co-axial feed point is connected to the radiator in the centre a shorter side of the radiator.

5. An antenna according to claim 1 wherein the electrical conductor forming the radiator has four non-conductive slots formed therein.
